(19) United States
(12) Patent Application Publication
(10) Pub. No.: US 2016/0183730 A1
(43) Pub. Date: Jun. 30, 2016

(54) WIRELESS, TEMPERATURE-CONTROL BEVERAGE WARMER

(71) Applicants: Design HMI LLC, Dearborn Heights, MI (US); Advanced Materials Enterprises Company Limited, Shatin (HK)

(72) Inventors: Sukhminder Bedi, Dearborn Heights, MI (US); Wing Yiu Yeung, Shatin (HK)

(21) Appl. No.: 14/678,460

(22) Filed: Apr. 3, 2015

Related U.S. Application Data
(60) Provisional application No. 62/096,709, filed on Dec. 24, 2014.

(51) Int. Cl. A47J 41/00; A47G 19/22

(52) U.S. Cl. CPC A47J 41/005; A47J 41/0072; A47G 19/2288

(57) ABSTRACT

A portable beverage warmer having an insulative main body, insulative base and a conductive sleeve. Electrical components are held in the insulative base, allowing for portability of the beverage warmer. A nano heater is used as the heating element. A rechargeable battery is also provided in the insulative base to allow a user to take the beverage warmer on-the-go while keeping the beverage heated at an ideal drinking temperature.

### CROSS-REFERENCE TO RELATED APPLICATIONS

This application claims benefit of U.S. Provisional Patent Application No. 62/096,709, filed Dec. 24, 2014, which is hereby incorporated by reference in its entirety.

### BACKGROUND OF THE INVENTION

The present invention relates generally to a beverage warmer, more particularly, to a wireless, portable, temperature-control beverage cup capable of keeping a hot beverage at an ideal drinking temperature.

Hot beverages can cool quickly, requiring frequent refills or reheating. Reheating hot beverages, especially coffee or tea, can reduce the taste of the beverage. Furthermore, many people are now “on-the-go,” and do not have easy access to a stove, microwave, or other heating element to reheat a beverage. Hot beverages naturally get cold, especially in cold climates, often within 15 minutes, limiting the amount of time a user can spend enjoying his/her hot beverage.

One solution to this problem has been the use of heating or warming plates. These heating plates can be used to keep hot beverages warm, while a user enjoys his or her beverage at an ideal temperature. However, these heating plates have a number of drawbacks. First, heating plates have cords, requiring the consumer or user to stay in one place. Second, the heating plate heats only the bottom part of the cup, so the top drinking stays lukewarm. Third, the heating plate requires constant connection to a power outlet, which is often unavailable, especially for those on-the-go or in an office setting. Fourth, heating plates are hot to the touch, increasing the possibility of harm to the consumer or user and other surrounding people, especially children. Fifth, the heating plate is a separate apparatus, requiring the consumer to carry a second apparatus to keep his/her coffee warm, which can be cumbersome and generally impractical.

Furthermore, conventional heating elements generally use metal coils, which suffer from low heating efficiency and high power loss. The present invention addresses one or more of the problems prevalent in prior heating methods.

### SUMMARY OF THE INVENTION

In accordance with the present invention, various embodiments of a wireless, temperature control beverage warmer are disclosed.

In one aspect of the invention, the beverage warmer has utilized and integrated with a unit of nano heater, which comprises a high energy efficiency ultra-thin heating element capable to be driven for heat generation at low voltage and receive power from battery power sources, USB power sources or wireless power sources. The nano heater comprises an ultra-thin continuous layer of heating element deposited and lying across the heater surface such that heat energy can be distributed closely and uniformly across the heater and the full base of the heat conductive sleeve lining of the beverage warmer. The beverage warmer can maintain a temperature between 140 degrees F. (60 degrees C.) to 155 degrees F. (68 degrees C.) for a set period of time. For example, the beverage warmer in accordance with one aspect of the invention can keep a beverage warm between 140 degrees F. (60 degrees C.) to 155 degrees F. (68 degrees C.) for 45 minutes after the beverage has been poured.

For example, a starting temperature for the beverage of 180 degrees F.+/−5 degrees F. (80 degrees C.-85 degrees C.) is presumed. A nano heating element allowing dynamic heating can be integrated in the beverage warmer in accordance with the present invention to provide an ideal drinking temperature for a user.

Exemplary dimensions for the beverage warmer are 85 mm for the interior cup, with an external exemplary height around or under 130 mm. A rounded lip can also be incorporated into the design. A snap fit insulated lid with sipping port can also be included.

Lining & Sleeve: The beverage warmer can be double-lined with 1.5 mm inner lining and a 1.5 mm outer lining, for example, with an air gap for insulation created there between. The beverage warmer can also have a stainless steel sleeve, which extends partway up the side of the cup, for example, 40 mm in height. The beverage warmer is also designed to keep the entire beverage warm, instead of just the bottom, as in the case of the prior methods using heating plates.

Switch: The cup can also be provided with an ON/OFF switch. When the cup is turned ON, the base of the cup may have a lighted blue ring to indicate to the user that the heating element is on.

Timer Element: The beverage warmer can also have a 30 or 45 minute timer, as designed on purpose, to turn OFF the nano heating element to eliminate battery drain while maintaining the beverage at the ideal drinking temperature between 140 degrees F. (60 degrees C.) to 155 degrees F. (68 degrees C.).

Indicator Element: The beverage warmer can also have a red flashing indicator when the battery level falls below 25% of full power. The battery indicator can also be such that it is only lit when the cup is turned on.

Charging: The beverage warmer can be charged through USB cable (via computer, for example) or through a conventional wall socket. The nano heater can be either ON or OFF when the battery is being charged. The indicator generally is red during charging and changes to blue once the battery is fully charged.

Weight: In one exemplary embodiment, the beverage warmer weighs less than 400 g, making the beverage warmer easy to carry and transport for the user.

Battery: In one exemplary embodiment, the battery is a UL or CE certified battery with 5000 mAh rechargeable battery. The battery pack can be such that it can power 7 cup serving or more before requiring recharging. The use of a rechargeable battery allows a user to carry and keep warm his or her beverage without being wired to a wall socket.

Nano Heater: In one exemplary embodiment, the nano heater comprises at least one layer of insulating material in nano-thickness, at least one layer of heat generation conductive material in nano-thickness, and at least two electrodes. The term “nano-thickness” refers to a thickness of each coating layer only measurable in nanometer at the nanometer level. An exemplary nano heater for a food warmer device is generally disclosed in U.S. Pat. No, 8,203,105 to Li et al., which disclosure is hereby incorporated by reference in its entirety. In another exemplary embodiment, the nano heater comprises at least one layer of heat generation conductive material in nano-thickness, and at least two electrodes.

In an exemplary embodiment, a portable beverage warmer comprises: an insulative main body; an insulative base; a heat conductive sleeve held in said insulative main body; wherein the heat conductive sleeve is of a height in between one-third and third-fourths of an interior height of the portable beverage warmer; a nano heater held in said insulative base to generate and transfer heat to said conductive sleeve; wherein the nano heater comprises a continuous conductive layer of heating element in nano-thickness deposited upon the surface of the nano heater; and a rechargeable battery held said insulative base to provide power to said nano heater.

In another exemplary embodiment, a portable beverage warmer comprises: an insulative main body; an insulative base; a heat conductive sleeve held in said insulative main body; a nano heater held in said insulative base to generate and transfer heat to said conductive sleeve; and a rechargeable battery held in said insulative base to provide power to said nano heater; wherein said heat conductive sleeve is of a height in between one-third and third-fourths of the interior height of the beverage warmer; wherein said nano heater comprises an insulative layer and a conductive layer, wherein said insulative layer is about 30 to 50 nm in thickness and said conductive layer is between 50 and 70 nm in thickness; wherein the portable beverage warmer weighs less than 400 g; wherein an air gap is provided between the insulative main body and heat conductive sleeve; wherein a light guide is provided between said insulative main body and insulative base; wherein a USB port is built in the beverage warmer and a USB cable can be used to charge said rechargeable battery; wherein said insulative main body is approximately 16 oz. in volume; wherein said insulative base further comprises a switch; wherein said insulative base further comprises a temperature control unit; wherein said insulative base further comprises a timer; and wherein said insulative base further comprises a battery power indicator.

The above summary is not intended to represent each embodiment or every aspect of the present invention. Particular embodiments may include one, some, or none of the listed features.

### BRIEF DESCRIPTION OF THE DRAWINGS

FIG. 1 shows a cross-sectional view of an exemplary portable beverage warmer in accordance with one aspect of the present invention;

FIG. 2 shows an exploded view of the exemplary portable beverage warmer shown in FIG. 1;

FIG. 3 shows and exploded view of an exemplary portable beverage warmer in accordance with one aspect of the present invention; and

FIG. 4 is a block diagram of an exemplary portable beverage warmer in accordance with one aspect of the present invention.

### DETAILED DESCRIPTION OF THE DRAWINGS

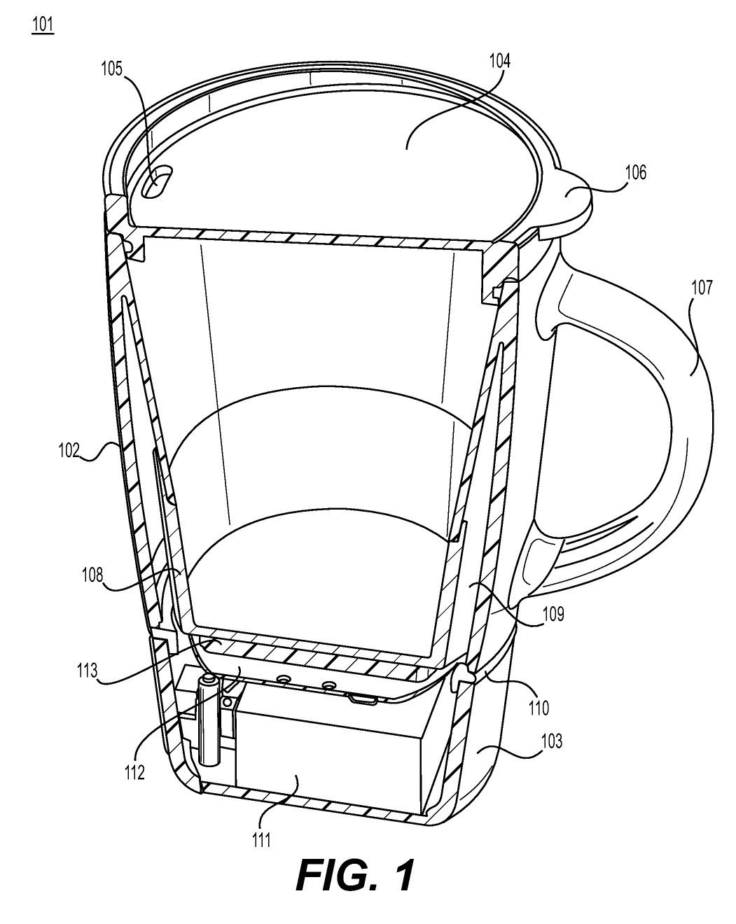

FIG. 1 shows a cross-sectional view of an exemplary portable beverage warmer 101 in accordance with one aspect of the present invention. Portable beverage warmer 101 generally comprises an insulative main body 102 and an insulative base 103.

Insulative main body 102 has a lid 104, which mates with main body 102. Cover 104 also can have a drinking hole or sipping port 105 and tab 106 for easy lid removal. Main body 102 also has a handle 107 for easy portability. Lower portion of main body 102 is lined with a conductive sleeve 108, which transfers heat to the beverage. Air gap 109 is created between main body 102 and conductive sleeve 108 to reduce heat loss.

Conductive sleeve 108 can be stainless steel or other conductive material for effective heat transfer. Between insulative main body 102 and base 103 may be a light guide 110, which lights during power-ON and turns off during power-OFF, to indicate status to the user.

Base 103 of the portable beverage warmer 101 generally houses the electrical components of the portable beverage warmer 101, for example, battery 111, printed circuit board (PCB) 112 and nano heater 113. Printed circuit board 112 can be a double-sided PCB to allow components to be placed on both sides of PCB 112. Battery 111 is rechargeable and can be a lithium ion battery, for example. A temperature control unit (not shown) may also be provided.

Nano heater 113 comprises at least one layer of insulating material in nano-thickness, at least one layer of heat generation conductive material in nano-thickness, and at least two electrodes. In one example, each layer of insulating material is about 30 to 50 nm in thickness, and each layer of conductive material is about 50-70 nm in thickness. Known nano technology methods can be used to deposit these layers, for example, using spray pyrolysis. Conductive materials used can be one or more or a combination of the following: tin, indium, cadmium, tungsten, titanium and vanadium with organometallic precursors.

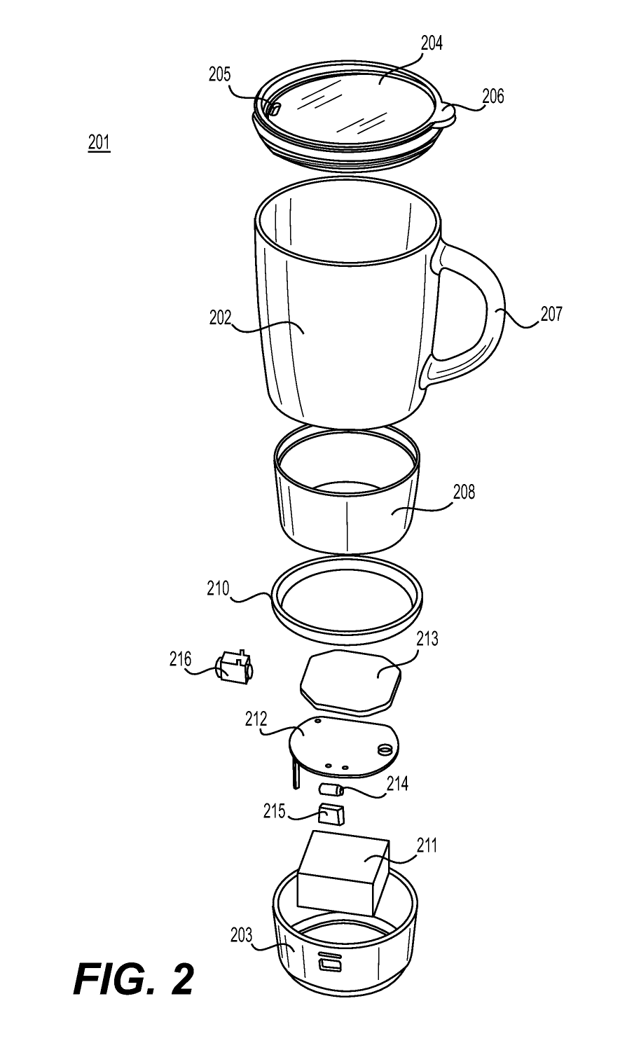

FIG. 2 shows an exploded view of the exemplary portable beverage warmer shown in FIG. 1. Portable beverage warmer 201 comprises an insulative main body 202 and an insulative base 203.

Insulative main body 202 has a lid 204, which mates with main body 202. Lid 204 also can have a drinking hole or sipping port 205 and tab 206 for easy lid removal. Main body 202 also has a handle 207 for easy portability. Lower portion of main body 202 is lined with a conductive sleeve 208, which transfers heat to the beverage. An air gap (not shown) is created between main body 202 and conductive sleeve 208 to reduce heat loss.

Conductive sleeve 208 can be stainless steel or other conductive material for effective heat transfer. Between insulative main body 202 and base 203 may be a light guide 210, which lights during power-ON and turns off during power-OFF, to indicate status to the user.

Base 207 of the portable beverage warmer 201 houses the electrical components of the portable beverage warmer 201. In this example, battery 211, printed circuit board 212, nano heater 213, ON/OFF switch 214, IC 215, and DC jet 216 are shown.

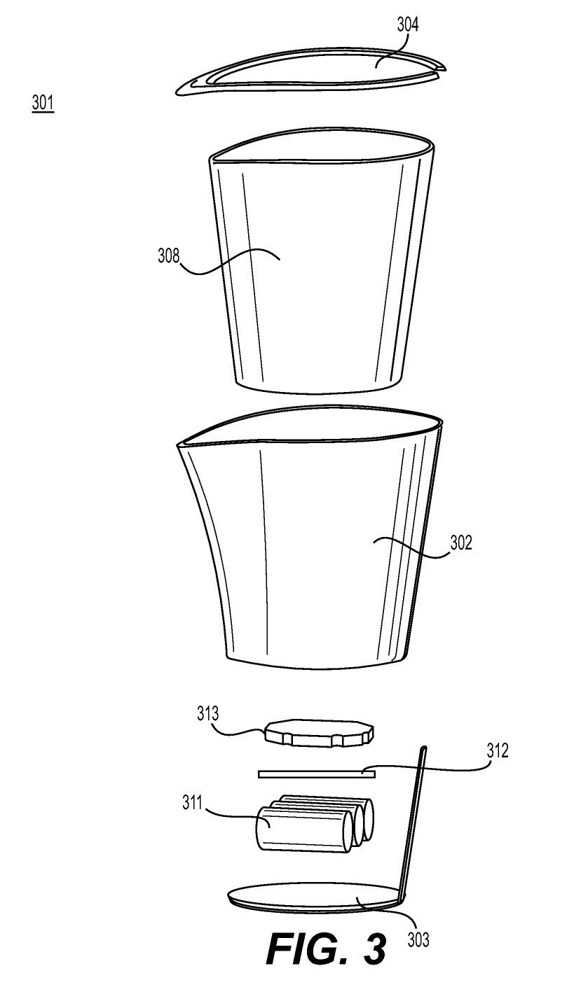

FIG. 3 shows an exploded view of an exemplary portable beverage warmer in accordance with another aspect of the present invention. In this embodiment, portable beverage warmer 301 is adapted to be used in a vehicle. Portable beverage warmer 301 is generally sized to fit in a cup holder of a vehicle.

Portable beverage warmer 301 has an insulative main body 302 and insulative base 303. Lid 304 can be used to cover insulative main body 302. Held in insulative main body 302 is conductive sleeve 308. Held in insulative base are battery 311, printed circuit board 312 and nano heater 313. Other electrical components (not shown) can also be held in the insulative base to operate the portable beverage warmer 301. Among other components may be a temperature control unit (not shown).

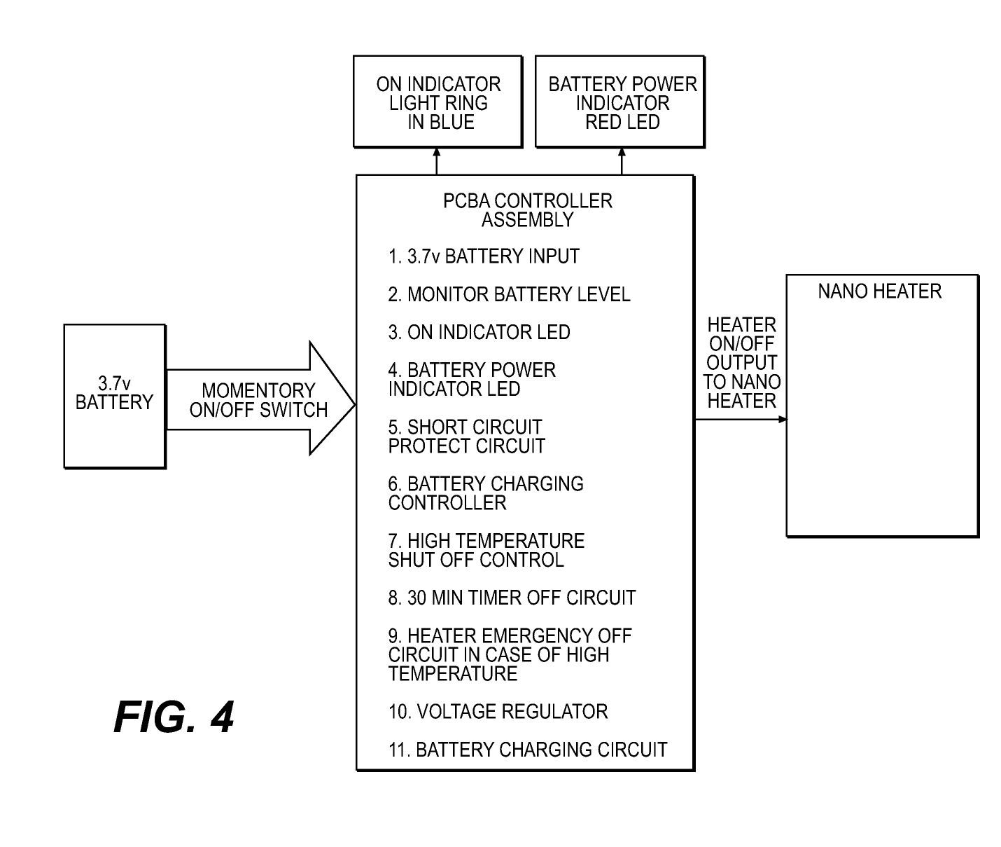

FIG. 4 is a block diagram of the exemplary portable beverage warmer in accordance with one aspect of the present invention. In this example, momentory OFF/ON switch controls power from the 3.7 v battery to the PCBA controller assembly. PCBA controller assembly comprises one or more of the following: 3.7 v battery input, monitor battery level, ON indicator LED, batter power indicator LED, short circuit protect circuit, battery charging controller, high temperature shut off control, 30 minute timer OFF circuit, heater emergency off circuit in case of high temperature, a voltage regulator, and a battery charging circuit. Also connected the PCBA controller assembly can be an ON indicator light ring (in blue) and batter power indicator LED (in red). Also connected to PCBA controller assembly is the nano heater.

Exemplary battery requirements for the portable cup warmer are as follows: operating voltage=3.7V; minimum cut-off voltage=3V; running current=1.4 A; battery life=1 year; run time per cycle=30 minutes; power and energy requirement per cycle=5 W (4.6 W heater+0.1 W LED) & 9000 J or 3.0 W (2.6 W heater+0.1 W LED) & 5400 J; proposed battery requirements=3.7V & 5000 m Ah (66600 J energy) or 3.7 & 3000 m Ah (39960 J energy); voltage and current control PCBA=3.7 & 70 mA; key off current=less than 20 micro-amps; and number of cycles (max) before recharge=7.

Numerous challenges were faced in developing a working portable beverage warmer in accordance with the present invention. For example, a battery that is able to provide sufficient power to the beverage warmer while being compact enough to be packaged in the cup base was one challenge. Identifying and developing the appropriate heating technology (nano-heater) and integrating the nano-heater into the design posed its own challenges. The heater must be highly energy efficient with very low energy loss and consume very small amount of energy to maximize the service time of the battery, and with a maximized heating area across the full base of the beverage warmer to effectively warm up and maintain the temperature of the beverage inside. Design testing and developing the cup's metal lining and insulated lining was also a challenge. The height of the metal lining is optimized in design of this invention in order to maximize the heat transfer to warm the beverage uniformly inside the beverage warmer and minimize the heat loss to the outside surroundings. Furthermore, keeping the overall weight of the cup (for example, less than 400 g) for maximum portability and drinking comfort was an additional challenge. Designing and validating features such as the time and functional lighting was another. Also, designing a charging system capable of efficient, fast charging was also an issue.

Furthermore, temperature test data on a variety of cups and mugs (coral cup, ceramic cup, insulated paper cup, double line plastic mugs, double line steel cup, double line steel mug) were performed to confirm that the portable beverage warmer in accordance with this invention performs far superior to previous methods.

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A portable beverage warmer comprising:
an insulative main body;
an insulative base;
a heat conductive sleeve held in said insulative main body;
wherein said heat conductive sleeve is of a height between one-third and third-fourths of an interior height of the portable beverage warmer;
a nano heater held in said insulative base to generate and transfer heat to said heat conductive sleeve;
wherein said nano heater comprises a continuous conductive layer of heating element in nano-thickness deposited upon a surface of said nano heater; and
a rechargeable battery held said insulative base to provide power to said nano heater.

2. A portable beverage warmer comprising:
an insulative main body;
an insulative base;
a heat conductive sleeve held in said insulative main body;
a nano heater held in said insulative base to generate and transfer heat to said conductive sleeve; and
a rechargeable battery held in said insulative base to provide power to said nano heater.

3. The portable beverage warmer according to claim 2, wherein said heat conductive sleeve is of a height in between one-third and third-fourths of an interior height of the portable beverage warmer;

4. The portable beverage warmer according to claim 2, wherein said nano heater comprises an insulative layer and a conductive layer, wherein said insulative layer is about 30 to 50 nm in thickness and said conductive layer is between 50 and 70 nm in thickness.

5. The portable beverage warmer according to claim 2, wherein the portable beverage warmer weighs less than 400 g.

6. The portable beverage warmer according to claim 2, wherein an air gap is provided between the insulative main body and heat conductive sleeve.

7. The portable beverage warmer according to claim 2, wherein a light guide is provided between said insulative main body and insulative base.

8. The portable beverage warmer according to claim 2, wherein a USB port is built in the beverage warmer and a USB cable can be used to charge said rechargeable battery.

9. The portable beverage warmer according to claim 2, wherein said insulative main body is approximately 16 oz. in volume.

10. The portable beverage warmer according to claim 2, wherein said insulative base further comprises a switch.

11. The portable beverage warmer according to claim 2, wherein said insulative base further comprises a temperature control unit.

12. The portable beverage warmer according to claim 2, wherein said insulative base further comprises a timer.

13. The portable beverage warmer according to claim 2, wherein said insulative base further comprises a battery power indicator.
